(19) United States
(12) Patent Application Publication
(10) Pub. No.: US 2018/0340504 A1
(43) Pub. Date: Nov. 29, 2018

(54) CONTROL DEVICE FOR ENGINE AND CONTROL METHOD OF ENGINE

(71) Applicant: TOYOTA JIDOSHA KABUSHIKI KAISHA, Toyota-shi (JP)

(72) Inventor: Hiroshi ENOMOTO, Nisshin-shi (JP)

(73) Assignee: TOYOTA JIDOSHA KABUSHIKI KAISHA, Toyota-shi (JP)

(21) Appl. No.: 15/967,801

(22) Filed: May 1, 2018

(30) Foreign Application Priority Data
May 24, 2017 (JP) 2017-102854

(51) Int. Cl. F02N 11/08

(52) U.S. Cl. CPC F02N 11/0844; F02N 11/0818; F02N 2300/2011; F02N 2200/022; F02N 2200/021

(57) ABSTRACT

The application discloses a control device and a control method for an engine. The control device includes an electronic control unit configured to execute a stop-and-start control of automatically stopping the engine when a predetermined automatic stop condition is established and automatically restarting the engine when a predetermined automatic-restart condition is established during the automatic stop of the engine, and in a case where the automatic-restart condition is established during fuel cut-off according to the automatic stop of the engine, prohibit detection of the toothless part based on the pulse signal output from the crank angle sensor, for a period until the crankshaft is rotated by a predetermined crank angle or more after the automatic-restart condition is established.

### INCORPORATION BY REFERENCE

The disclosure of Japanese Patent Application No. 2017-102854 filed on May 24, 2017 including the specification, drawings and abstract is incorporated herein by reference in its entirety.

### BACKGROUND

### 1. Technical Field

The present disclosure relates to a control device and a control method for an engine mounted in a vehicle.

### 2. Description of Related Art

In an engine (internal combustion engine), a crank position of a crankshaft is detected by a timing rotor provided on the crankshaft and a crank angle sensor, and fuel injection and ignition for a cylinder are controlled. In an engine in which a stop-and-start control can be executed, it is known that a restart control of the engine is performed by performing cylinder discrimination based on a toothless part provided on the timing rotor of the crankshaft and the output from a cam angle sensor at the engine stop time (for example, Japanese Unexamined Patent Application Publication No. 2012-062802 (JP 2012-062802 A)).

### SUMMARY

In a case where the crank position of the crankshaft is detected by the timing rotor having a toothless part and the crank angle sensor, the toothless part of the timing rotor may be erroneously detected due to the rotational deviation and the decrease in rotation speed of when the crank rotation speed is slow and the top dead center (TDC) is exceeded, and thus the precision of detecting the crank position may deteriorate. In particular, in a case where an engine start is performed by only combustion without using a starter, since the crank rotation speed is extremely slow and a change rate of rotation fluctuation is large, in some cases, the decrease in rotation speed of when the top dead center is exceeded may erroneously be detected as the toothless part of the timing rotor. In a case where the exceeding of the top dead center is erroneously detected as the toothless part of the timing rotor, the crank position is erroneously detected, and thus the startability of the engine may deteriorate.

The disclosure provides a control device and a control method for an engine including a timing rotor provided with a toothless part and a crank angle sensor configured to output a pulse signal according to passing of a tooth of the timing rotor, the control device being capable of suppressing erroneous detection of the toothless part of the timing rotor.

In the disclosure, in a stop-and-start control, under a condition in which the crank rotation speed is slow, for example, in a case where the engine is restarted by only combustion without using a starter, the detection of the toothless part (toothless part detection) of the timing rotor is prohibited so that the erroneous detection of the toothless part of the timing rotor is suppressed.

A first aspect of the disclosure relates to a control device for an engine. The engine includes a crank angle sensor, and a timing rotor provided on a crankshaft of the engine. The timing rotor is provided with a plurality of teeth and a toothless part where at least one of the teeth is not provided on an outer periphery of the timing rotor. The crank angle sensor is configured to output a pulse signal according to the passing of the teeth of the timing rotor. The control device includes an electronic control unit. The electronic control unit is configured to execute a stop-and-start control of automatically stopping the engine when a predetermined automatic stop condition is established and automatically restarting the engine when a predetermined automatic-restart condition is established during the automatic stop of the engine. The electronic control unit is configured to, when the automatic-restart condition is established during fuel cut-off according to the automatic stop of the engine, prohibit detection of the toothless part of the timing rotor based on the pulse signal output from the crank angle sensor, for a period until the crankshaft is rotated by a predetermined crank angle or more after the automatic-restart condition is established.

According to the first aspect of the disclosure, the erroneous detection of the toothless part of the timing rotor can be suppressed. This point will be described. Even in a case where the engine is restarted by only combustion without using a starter, since the crank rotation speed is increased at the restart time of the engine, when the crankshaft is rotated to some extent, the crank rotation speed reaches a rotation speed at which the detection of the toothless part is possible. In consideration of this, in the first aspect of the disclosure, the detection of the toothless part is prohibited for a period until the crankshaft is rotated by a predetermined crank angle or more after a start request is made, and thus the erroneous detection of the toothless part of the timing rotor can be suppressed.

In the control device according to the first aspect of the disclosure, the predetermined crank angle may be set based on a period during which a rotation speed of the crankshaft (a crank rotation speed) is increased to a rotation speed at which the detection of the toothless part is possible after the automatic-restart condition is established.

A second aspect of the disclosure relates to a control device for an engine. The engine includes a crank angle sensor, and a timing rotor provided on a crankshaft of the engine. The timing rotor is provided with a plurality of teeth and a toothless part where at least one of the teeth is not provided on an outer periphery of the timing rotor. The crank angle sensor is configured to output a pulse signal according to the passing of the teeth of the timing rotor. The control device includes an electronic control unit. The electronic control unit is configured to calculate a pulse input interval time when the pulse signal is input from the crank angle sensor. The electronic control unit is configured to calculate a pulse input interval ratio that is a ratio of a current pulse input interval time to a previous pulse input interval time. The electronic control unit is configured to prohibit detection of the toothless part based on the pulse signal output from the crank angle sensor when the calculated pulse input interval ratio is a value at which a predetermined toothless part determination ratio is established, in a case where the previous pulse input interval time of when the pulse input interval ratio is calculated is equal to or greater than a predetermined determination time.

According to the second aspect of the disclosure, the erroneous detection of the toothless part of the timing rotor can be suppressed. This point will be described. Even in a case where the piston passes the top dead center, the pulse input interval ratio that is the ratio of the current pulse input interval time to the previous pulse input interval time may be a value at which the toothless part determination ratio is established. However, when the piston passes the top dead center, since the crank rotation speed is slow, the pulse input interval time becomes longer than a pulse input interval time at a crank rotation speed at which the detection of the toothless part is possible. In consideration of this, in the second aspect of the disclosure, in a case where the pulse input interval ratio that is the ratio of the current pulse input interval time to the previous pulse input interval time is a value at which the predetermined toothless part determination ratio is established, when the previous pulse input interval time is equal to or greater than a predetermined determination time, the detection of the toothless part is prohibited, and thus the erroneous detection of the toothless part of the timing rotor can be suppressed.

In the control device according to the second aspect of the disclosure, the predetermined determination time may be set based on a crank rotation speed (rotation speed of the crankshaft) at which there is a possibility of erroneously detecting the toothless part.

A third aspect of the disclosure relates to a control method for an engine. The engine includes a crank angle sensor and a timing rotor provided on a crankshaft of the engine. The timing rotor is provided with a plurality of teeth and a toothless part where at least one of the teeth is not provided on an outer periphery of the timing rotor. The crank angle sensor is configured to output a pulse signal according to passing of the teeth of the timing rotor. The engine is controlled by an electronic control unit. The control method includes: executing, by the electronic control unit, a stop-and-start control of automatically stopping the engine when a predetermined automatic stop condition is established and automatically restarting the engine when a predetermined automatic-restart condition is established during the automatic stop of the engine; and when the automatic-restart condition is established during fuel cut-off according to the automatic stop of the engine, prohibiting, by the electronic control unit, detection of the toothless part of the timing rotor based on the pulse signal output from the crank angle sensor, for a period until the crankshaft is rotated by a predetermined crank angle or more after the automatic-restart condition is established.

A fourth aspect of the disclosure relates to a control method for an engine. The engine includes a crank angle sensor and a timing rotor provided on a crankshaft of the engine. The timing rotor is provided with a plurality of teeth and a toothless part where at least one of the teeth is not provided on an outer periphery of the timing rotor. The crank angle sensor is configured to output a pulse signal according to passing of the teeth of the timing rotor. The engine is controlled by an electronic control unit. The control method includes: calculating, by the electronic control unit, a pulse input interval time when the pulse signal is input from the crank angle sensor; calculating, by the electronic control unit, a pulse input interval ratio, the pulse input interval ratio is a ratio of a current pulse input interval time to a previous pulse input interval time; and when the calculated pulse input interval ratio is a value at which a predetermined toothless part determination ratio is established, prohibiting, by the electronic control unit, detection of the toothless part of the timing rotor based on the pulse signal output from the crank angle sensor in a case where the previous pulse input interval time of when the pulse input interval ratio is calculated is equal to or greater than a predetermined determination time.

According to the aspects of the disclosure, in an engine including a timing rotor provided with a toothless part, and a crank angle sensor configured to output a pulse signal according to the passing of teeth of the timing rotor, the erroneous detection of the toothless part of the timing rotor can be suppressed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a schematic configuration of an engine to which the disclosure is applied;

FIG. 2 is a diagram illustrating a timing rotor provided on a crankshaft;

FIG. 3 is a diagram illustrating a timing rotor provided on a camshaft;

FIG. 4 is an explanatory diagram of a crank signal, a cam signal, and a crank counter;

FIG. 5 is a block diagram illustrating a configuration of a control system of an electronic control unit (ECU) and the like;

FIG. 6 is an explanatory diagram of a pulse input interval time;

FIG. 7A is an explanatory diagram of a pulse input interval time;

FIG. 7B is an explanatory diagram of a pulse input interval time;

FIG. 8 is a flowchart illustrating an example of a toothless part detection control that the ECU executes;

FIG. 9 is a flowchart illustrating another example of a toothless part detection control that the ECU executes; and

FIG. 10 is a graph illustrating a relationship between a crank rotation speed and a pulse input interval ratio at a top dead center.

### DETAILED DESCRIPTION OF EMBODIMENTS

Hereinafter, embodiments of the disclosure will be described with reference to the drawings.

Engine

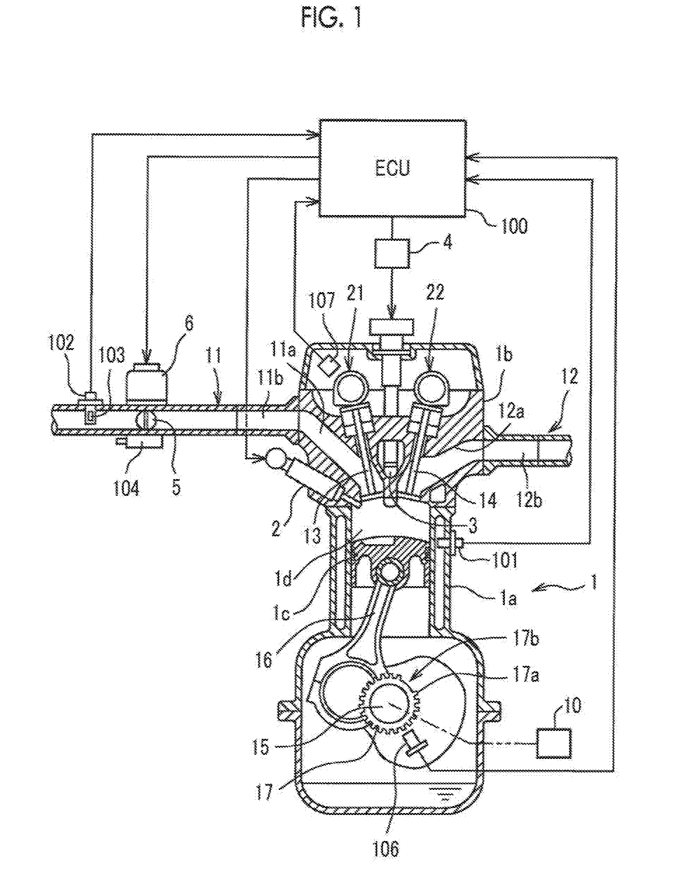

FIG. 1 is a diagram illustrating a schematic configuration of an engine (internal combustion engine) to which the disclosure is applied. In FIG. 1, only the configuration of one cylinder of the engine is illustrated.

An engine 1 of the embodiment is a cylinder injection engine having four cylinders (first cylinder #1 to fourth cylinder #4) mounted in a vehicle, and a piston 1c which reciprocates in an up-down direction is provided in a cylinder block 1a that constitutes each cylinder. The piston 1c is connected to a crankshaft 15 via a connecting rod 16, and the reciprocation of the piston 1c is converted into the rotation of the crankshaft 15 via the connecting rod 16.

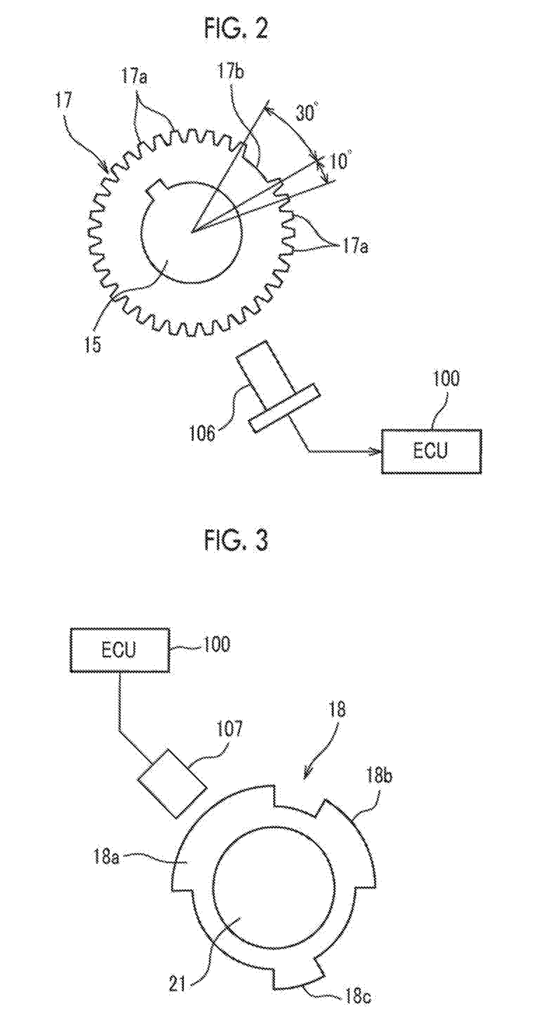

A timing rotor 17 is attached to the crankshaft 15. A plurality of teeth (projections) 17a is provided on the outer periphery of the timing rotor 17 such that the teeth 17a are disposed at an equal angle. The timing rotor 17 includes a toothless part 17b where the teeth 17a are not provided. Specifically, as illustrated in FIG. 2, 34 teeth 17a are provided at 10° on the timing rotor 17 of the embodiment, and an angle range of the toothless part 17b where two teeth 17a are not provided is set to 30°.

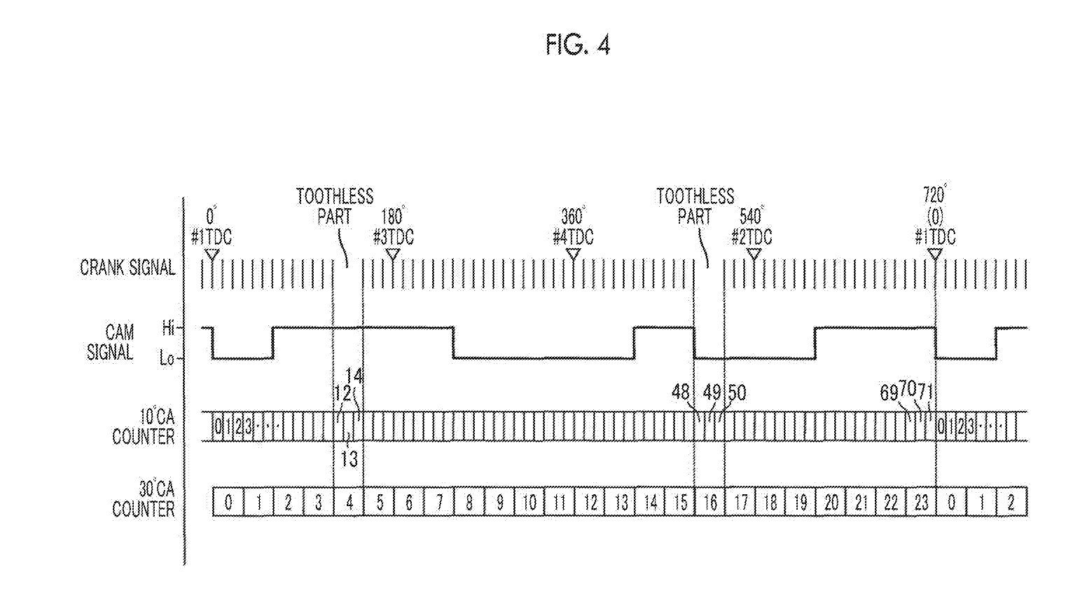

A crank angle sensor 106 which detects the rotation angle of the crankshaft 15, that is, the crank position of the crankshaft 15 is provided near the timing rotor 17 to be disposed on the side of the timing rotor 17. The crank angle sensor 106 is, for example, an electromagnetic pickup, and outputs a pulse signal (hereinafter, referred to as a crank signal) according to the passing of the teeth 17a of the timing rotor 17 when the crankshaft 15 is rotated. The crank signal output from the crank angle sensor 106 is input to an electronic control unit (ECU) 100 to be described later, and is used for calculating an engine speed. In the ECU 100, the crank signal is used, together with a cam signal to be described later, to generate a crank counter in which 720°, that is, two rotations of the crankshaft 15 are set as one cycle (refer to FIG. 4). During the operation of the engine 1, various controls are executed based on the crank counter.

A starter (motor) 10 which is activated at the start time of the engine 1 (engine start time by the ignition ON and the like) is connected to the crankshaft 15, and the crankshaft 15 is forcibly rotated (cranking) by the starter 10.

A coolant temperature sensor 101 which detects the temperature of the engine coolant is disposed in the cylinder block 1a of the engine 1. A cylinder head 1b is provided on an upper end of the cylinder block 1a, and a combustion chamber 1d is formed between the cylinder head 1b and the piston 1c. An ignition plug 3 is disposed in the combustion chamber 1d of the engine 1. The ignition timing of the ignition plug 3 is adjusted by an ignitor 4. The ignitor 4 is controlled by the ECU 100.

An intake flow path 11 and an exhaust flow path 12 are connected to the combustion chamber 1d of the engine 1. A part of the intake flow path 11 is formed by an intake port 11a and an intake manifold 11b. A part of the exhaust flow path 12 is formed by an exhaust port 12a and an exhaust manifold 12b.

In the intake flow path 11 of the engine 1, an air cleaner (not illustrated) which filters intake air, an air flowmeter 102, an intake-air temperature sensor 103, a throttle valve 5 for adjusting an amount of the intake air of the engine 1, and the like are disposed. The throttle valve 5 is driven by a throttle motor 6. The opening degree of the throttle valve 5 is detected by a throttle opening degree sensor 104. The throttle opening degree of the throttle valve 5 is controlled by the ECU 100. In the exhaust flow path 12, a three-way catalyst, an air-fuel-ratio sensor, an O₂ sensor, and the like are disposed.

An intake valve 13 is provided between the intake flow path 11 and the combustion chamber 1d, and the intake flow path 11 and the combustion chamber 1d are communicated to each other or blocked from each other by the intake valve 13 being driven to be opened or closed. An exhaust valve 14 is provided between the exhaust flow path 12 and the combustion chamber 1d, and the exhaust flow path 12 and the combustion chamber 1d are communicated to each other or blocked from each other by the exhaust valve 14 being driven to be opened or closed. The driving for opening and closing the intake valve 13 and the exhaust valve 14 is performed by rotation of an intake camshaft 21 and an exhaust camshaft 22 which is transmitted from the rotation of the crankshaft 15 via a timing chain or the like.

Each of the intake camshaft 21 and the exhaust camshaft 22 is rotated at a rotation speed which is half of the rotation speed of the crankshaft 15, and is rotated once while the piston 1c performs an intake stroke, a compression stroke, an expansion stroke, and an exhaust stroke. In each cylinder, the intake valve 13 is opened in the intake stroke, and the exhaust valve 14 is opened in the exhaust stroke. The intake camshaft 21 and the exhaust camshaft 22 are rotated once during one combustion cycle during which the crankshaft 15 is rotated twice (is rotated by 720°).

As illustrated in FIG. 3, a timing rotor 18 is attached to the intake camshaft 21 that is rotated as described above, three projection portions 18a, 18b, 18c are formed on the outer periphery of the timing rotor 18, and a cam angle sensor 107 is provided near the timing rotor 18 to be disposed on the side of the timing rotor 18.

The cam angle sensor 107 is a magneto resistive element (MRE) sensor, and outputs a rectangular-wave signal (cam signal) as illustrated in FIG. 4, according to the passing of each of the three projection portions 18a, 18b, 18c as the timing rotor 18 is rotated. That is, according to the passing of each of the projection portions 18a, 18b, 18c of the timing rotor 18, the cam angle sensor 107 outputs a high (Hi) signal for a period corresponding to a rotation angle of the timing rotor 18, and outputs a low (Lo) signal for a period corresponding to a section between the adjacent projection portions.

As described above, since the one rotation of the intake camshaft 21 corresponds to the two rotations of the crankshaft 15, according to the passing of the projection portion 18a of the timing rotor 18, the cam signal is in Hi for a period of, for example, a crank angle of 180°. In a section between the two projection portions 18a, 18b, the cam signal is in Lo for a period of, for example, a crank angle of 60°, and according to the passing of the projection portion 18b, the cam signal is in Hi for a period of, for example, a crank angle of 120°. In this manner, the cam signal is repeatedly inverted between Hi and Lo.

The rotation angle of the timing rotor 18, that is, the intake-side cam phase can be detected from the output (Hi, Lo) of the cam signal and the output (Hi→Lo, Lo→Hi) at the time of inversion. The crank counter can be generated by using the cam signal and the crank signal, and control of the fuel injection and the ignition of the engine 1 for the cylinder and the like can be performed at an appropriate timing based on the crank counter.

Specifically, as illustrated in FIG. 4, the crank counter is generated with the compression top dead center (compression TDC) of the first cylinder #1 as a reference (0). In this case, the cam angle sensor 107 outputs a signal of Hi→Lo (cam edge signal) according to the passing of an edge of a terminal end part of the projection portion 18b of the timing rotor 18, and the ECU 100 resets the crank counter according to the input of the cam edge signal.

Then, the crank counter is counted up according to the input of the crank signal from the crank angle sensor 106. As the crank counter, there are a 10° C.A counter that is counted up for every 10° C.A at which a crank signal is input, and a 30° C.A counter that is counted up whenever the crank signal is input three times (for every 30° C.A). The 10° C.A counter is used in a predetermined low-rotation region, for example, at the start time of the engine 1 or during the idling operation, and the 30° C.A counter is used in a rotation region other than the predetermined low-rotation region.

In the example illustrated in FIG. 4, parts corresponding to counter values of 12 to 14 and 48 to 50 of the 10° C.A counter correspond to the toothless part 17b of the timing rotor 17. In these parts, the ECU 100 can detect the toothless part by the crank signal not being output for a predetermined period. In a case where the cam signal is in Hi in the toothless-part corresponding part of the crank counter, the ECU 100 recognizes that the counter values of the 10° C.A counter are 12 to 14 (the counter value of the 30° C.A counter is four), and in a case where the cam signal is in Lo in the toothless-part corresponding part of the crank counter, the ECU 100 recognizes that the counter values of the 10° C.A counter are 48 to 50 (the counter value of the 30° C.A counter is five).

After the crankshaft 15 is rotated twice and thus the 10° C.A counter is counted up to 71 (or the 30° C.A counter is counted up to 23) including pseudo counts for the toothless-part corresponding part, the counter value is reset to “zero” (720° C.A→0° C.A). As described above, the crank counter is counted up while the four cylinders of which the phases are deviated from each other by 180° C.A perform a single combustion cycle in order (in this embodiment, in order of the first cylinder #1, the third cylinder #3, the fourth cylinder #4, and the second cylinder #2).

An injector 2 that can directly inject fuel into the combustion chamber 1d is disposed in the engine 1. The injector 2 is provided in each cylinder. Fuel stored in a fuel tank (not illustrated) is supplied to the injector 2, and thus an air-fuel mixture (fuel+air) is formed in the combustion chamber 1d. The air-fuel mixture is ignited by the ignition plug 3 to be combusted. The piston 1c reciprocates by the high-temperature and high-pressure combustion gas generated in this case, and thus the crankshaft 15 is rotated to obtain driving force (output torque) of the engine 1. The combustion gas combusted in the combustion chamber 1d is discharged to the exhaust flow path 12 as the exhaust valve 14 is opened. In the engine 1 having four cylinders, while the crankshaft 15 is rotated once (is rotated by 360°), the combustion (ignition) by the fuel injection and the ignition is performed in the cylinder twice.

In the embodiment, in order of the first cylinder #1, the third cylinder #3, the fourth cylinder #4, and the second cylinder #2, a single combustion cycle including four strokes of an intake stroke, a compression stroke, an expansion stroke, and an exhaust stroke is performed in each cylinder. The rotation speed of the crankshaft 15 is periodically changed such that, in each of cylinders #1 to #4, the rotation speed increases in the first half of the expansion stroke (until a top dead center (TDC) is reached) and the rotation speed decreases in the second half of the expansion stroke (after the TDC is exceeded).

ECU

The ECU 100 includes a central processing unit (CPU), a read only memory (ROM) that stores a program or the like for controlling each unit, a random access memory (RAM) that temporarily stores data, an input-output interface, and the like.

The ROM stores various control programs, a map that is referred to when the various control programs are executed, and the like. The CPU executes an arithmetic process based on the various control programs or the map stored in the ROM. The RAM is a memory that temporarily stores the arithmetic result of the CPU or data that is input from each sensor. A backup RAM is a non-volatile memory that stores data to be conserved at the stop time of the engine 1.

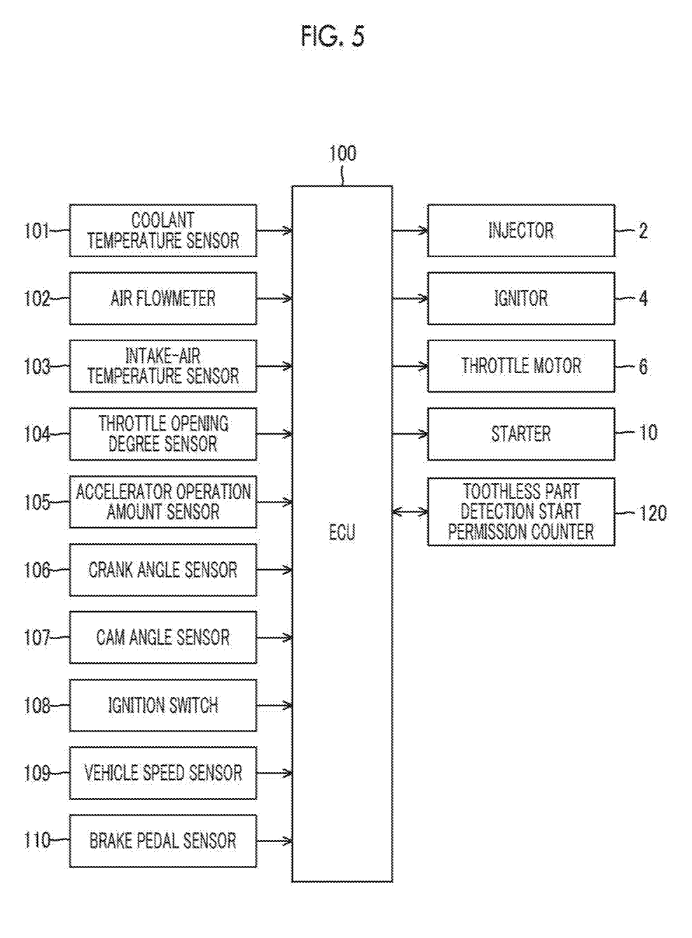

As illustrated in FIG. 5, various sensors such as the coolant temperature sensor 101, the air flowmeter 102, the intake-air temperature sensor 103, the throttle opening degree sensor 104, an accelerator operation amount sensor 105 that detects an accelerator operation amount as a stepped amount of an accelerator pedal (not illustrated), the crank angle sensor 106, the cam angle sensor 107, an ignition switch (start switch) 108, a vehicle speed sensor 109 that outputs a signal according to a vehicle speed of a vehicle, and a brake pedal sensor 110 that outputs a signal according to an operation amount of a brake pedal are connected to the ECU 100, and signals from the sensors (including switches) are input to the ECU 100.

The throttle motor 6 that drives the throttle valve 5 of the engine 1 for opening or closing the throttle valve 5, the injector 2, the ignitor 4 of the ignition plug 3, and the like are connected to the ECU 100.

A toothless part detection start permission counter 120 is connected to the ECU 100. The toothless part detection start permission counter 120 is a counter of which the increment starts at a time point when a start request of the engine 1 is made (at a time point when an automatic-restart condition to be described below is established) and which is counted up, for example, for every 10° C.A, according to the input of the pulse signal that is output from the crank angle sensor 106.

The ECU 100 executes various controls of the engine 1 based on the output signals from the various sensors. The various controls include an opening degree control of the throttle valve 5 of the engine 1 (an intake air amount control (a driving control of the throttle motor 6)), a fuel injection amount control (an opening and closing control of the injector 2), an ignition timing control (a driving control of the ignition plug 3), and the like.

The ECU 100 executes a “stop-and-start control” and a “toothless part detection control” described below.

Stop-and-Start Control

The stop-and-start control executed by the ECU 100 will be described.

In the stop-and-start control, an automatic stop is performed from an idling operation state of the engine 1, and an automatic restart of the engine 1 is performed from the automatic stop state.

Specifically, when a predetermined automatic stop condition is established during the operation of the engine 1, the engine 1 is automatically stopped. As the automatic stop condition, there are conditions such as the accelerator operation amount being “zero”, and the vehicle speed of the vehicle being equal to or less than a predetermined vehicle speed. In a case where all the above-described conditions are established, determination is made that the automatic stop condition is established. In a case where the automatic stop condition is established, the fuel injection to the cylinder from the injector 2 is stopped (fuel cut-off). In this manner, the engine 1 is stopped.

The automatic stop condition is merely an example and may be appropriately changed. For example, the automatic stop condition may include a brake pedal operation state of a driver, an air-conditioning state, a state of charge (SOC) of a battery, and the like.

After the engine 1 is automatically stopped, in a case where the automatic-restart condition of the engine 1 is established, the engine 1 is automatically restarted. In a case where any of the automatic stop conditions is not established, determination is made that the automatic-restart condition is established. In a case where the automatic-restart condition is established, the engine 1 is restarted.

As the stop-and-start control, there are a stop-and-start control that is executed during the vehicle traveling, and a stop-and-start control that is executed during a vehicle stop.

In the above-described stop-and-start control, in a case where the engine 1 is restarted, the engine start is performed by only combustion without using the starter 10. In the engine start by only combustion, the fuel injection and the ignition are performed in a cylinder of the engine 1 of which the piston position is in an expansion stroke (a cylinder that is stopped in an expansion stroke) to generate combustion in the cylinder, then the crankshaft 15 is driven to be rotated by the pressure of the combustion, and thereby the engine 1 is started without using the starter 10.

Toothless Part Detection Control

In the embodiment, in the stop-and-start control, at the stop time of the engine 1, the ECU 100 recognizes and stores the crank position based on the pulse signal output from the crank angle sensor 106. At the restart time of the engine 1, the ECU 100 detects the toothless part 17b (reference position of the crank position: hereinafter, simply referred to as “toothless part”) of the timing rotor 17 provided on the crankshaft 15 based on the pulse signal output from the crank angle sensor 106, and calculates (specifies) the crank position from the toothless part detection results. Whether there is a deviation between the calculated crank position and the crank position that the ECU 100 currently recognizes is checked, and in a case where determination is made that there is a deviation in the crank position based on the check results, the ECU 100 executes a control of correcting the crank position.

Here, in the stop-and-start control, when the engine 1 is restarted, in a case where an engine start (engine start by only combustion) in which the fuel injection and the ignition are performed in a cylinder of which the piston position is in an expansion stroke is executed, since the crank rotation speed (the rotation speed of the crankshaft 15) is extremely slow and a change rate of rotation fluctuation is large, in some cases, the decrease in rotation speed of when the top dead center is exceeded may erroneously be detected as the toothless part of the timing rotor. The above-described points are described.

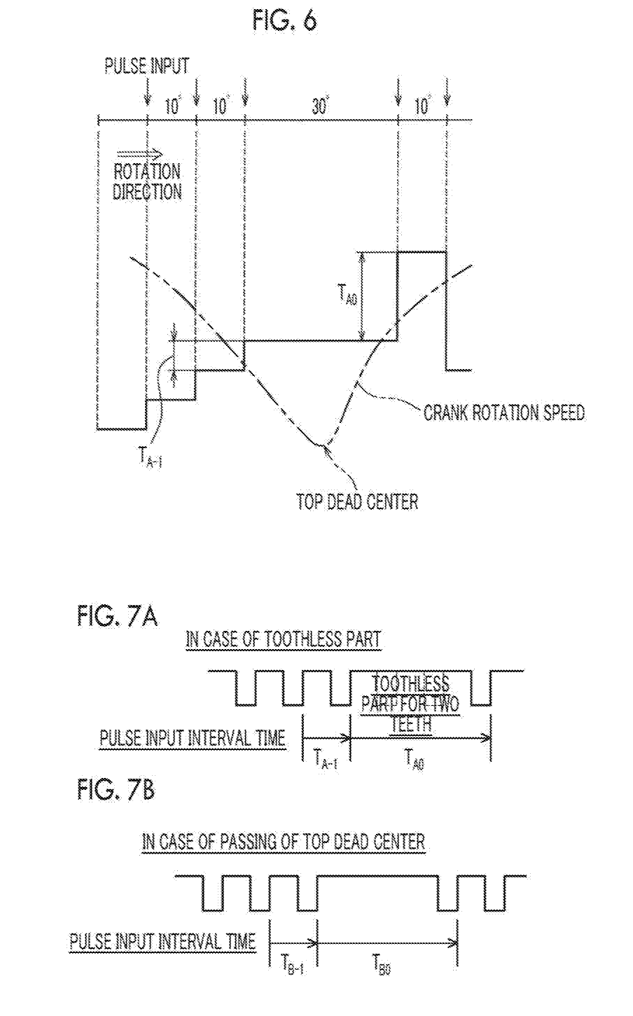

Whenever the pulse signal is input from the crank angle sensor 106, the ECU 100 calculates a pulse input interval time that is an interval time between the current pulse input and the previous pulse input, and calculates a ratio of the current pulse input interval time to the previous pulse input interval time (pulse input interval ratio) to perform toothless part detection. Specifically, as illustrated in FIG. 6 and FIG. 7A, in a case where a ratio of a current pulse input interval time T_{AO} to a previous pulse input interval time T_{A-1} (T_{AO}/T_{A-1}) is equal to or greater than a predetermined determination value (in this example, 2.4), the toothless part detection is permitted.

However, as illustrated in FIG. 7B, even when the top dead center is exceeded (refer to two-dot chain line in FIG. 6), the ratio of pulse input interval times (T_{BO}/T_{B-1}) may be similar to that in the case of the toothless part. In such a case, it is difficult to discriminate the exceeding of the top dead center and the toothless part, and thus the exceeding of the top dead center may erroneously be detected as the toothless part of the timing rotor, in some cases. In a case where the exceeding of the top dead center is erroneously detected as the toothless part of the timing rotor, the crank position is erroneously detected, and thus the startability of the engine 1 may deteriorate.

In this embodiment, in the stop-and-start control, under a condition in which the crank rotation speed is slow, for example, in a case where the engine 1 is restarted by only combustion, the toothless part detection is prohibited so that the erroneous detection of the toothless part of the timing rotor is suppressed.

A specific example of the control (toothless part detection control) will be described below.

Toothless Part Detection Control 1

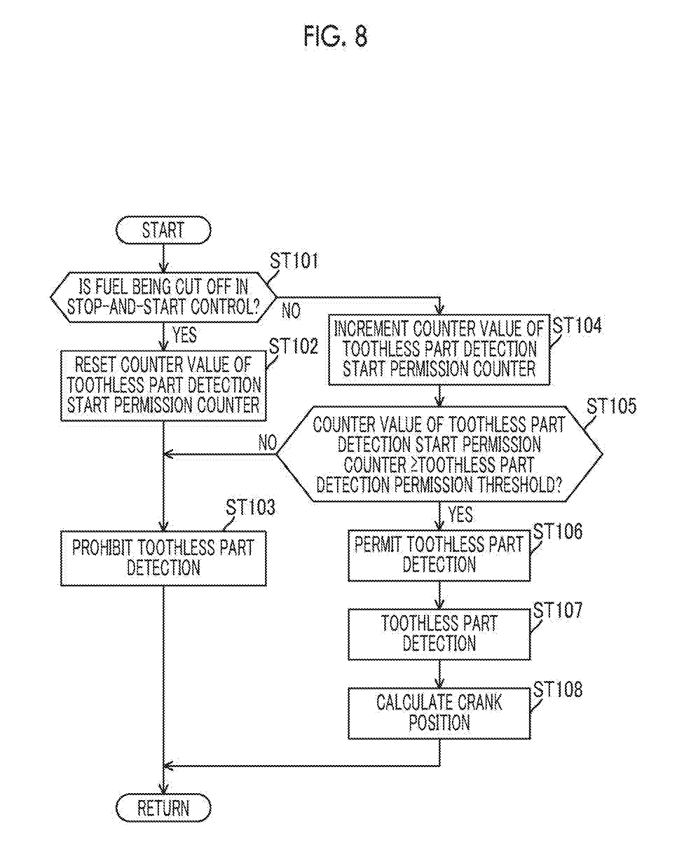

An example of the toothless part detection control executed by the ECU 100 is described with reference to the flowchart in FIG. 8. The control routine in FIG. 8 is repeatedly executed by the ECU 100 for every predetermined crank angle (for example, 10° C.A).

When the control routine in FIG. 8 is started, in step ST101, determination is made on whether the fuel is being cut off (during the automatic stop of the engine 1) in the stop-and-start control. In a case where the determination result is positive (YES), the process proceeds to step ST102.

In step ST102, the counter value of the toothless part detection start permission counter 120 is reset to “zero”. In step ST103, the toothless part detection is prohibited. In this manner, during the fuel cut-off in the stop-and-start control, the toothless part detection is prohibited.

Meanwhile, in a case where the determination result of step ST101 is negative (NO), that is, in a case where a start request of the engine 1 is made (the automatic-restart condition is established) to restart the fuel injection and the ignition for the cylinder, the process proceeds to step ST104. The fuel injection and the ignition are performed in a cylinder of the engine 1 of which the piston position is in an expansion stroke.

In step ST104, the counter value of the toothless part detection start permission counter 120 is incremented. Then, the process proceeds to step ST105.

In step ST105, determination is made on whether the counter value of the toothless part detection start permission counter 120 is equal to or greater than a toothless part detection permission threshold. The details of toothless part detection permission threshold will be described below.

In a case where the determination result of step ST105 is negative (NO) (the counter value of the toothless part detection start permission counter 120<toothless part detection permission threshold), the process returns to step ST103 to cause the prohibition of the toothless part detection to continue. During the prohibition of the toothless part detection, determination is made on whether the current crank position is correct based on the cam signal of the cam angle sensor 107.

After a start request is made, as the crankshaft 15 is rotated, the counter value of the toothless part detection start permission counter 120 is incremented, and when the counter value of the toothless part detection start permission counter 120 is equal to or greater than the toothless part detection permission threshold (the counter value of the toothless part detection start permission counter 120≥the toothless part detection permission threshold) (when the determination result of step ST105 is positive (YES)), the toothless part detection is permitted (step ST106).

When the toothless part detection is permitted, the toothless part detection is executed in step ST107. Specifically, in a case where the ratio of the current pulse input interval time to the previous pulse input interval time is equal to or greater than a predetermined determination value (in this example, 2.4), determination is made that the toothless part (the reference position of the crank position) is detected based on the pulse signal output from the crank angle sensor 106. The crank position is calculated based on the above-described determination of the toothless part (step ST108). Whether there is a deviation between the calculated crank position and the crank position that the ECU currently recognizes is checked, and in a case where determination is made that there is a deviation in the crank position, the crank position is corrected based on the check results.

Toothless Part Detection Permission Threshold

The toothless part detection permission threshold used in the determination of step ST105 will be described. Even in a case where the engine 1 is restarted by only combustion without using the starter 10, when the fuel injection and the ignition for the cylinder are performed, for example, twice, the crank rotation speed is increased up to a speed at which the detection of the toothless part 17b of the timing rotor 17 is possible. In consideration of this, in the case of the engine 1 having four cylinders, the toothless part detection is prohibited for a period until the crankshaft 15 is rotated by 360° (once) after a start request is made. That is, in this embodiment, when the crankshaft 15 is rotated by 360° or more after a start request is made, the toothless part detection is permitted. In consideration of this, in this embodiment, the toothless part detection permission threshold used in the determination of step ST105 is set to 36 (360°/10° (the crank angle whenever the toothless part detection start permission counter 120 is counted up)).

Step ST101 to step ST108 in FIG. 8 are executed by the ECU 100, and thereby “the control device of the engine” of the disclosure is implemented.

Effect

As described above, with the toothless part detection control according this example, when a start request is made during the fuel cut-off in the stop-and-start control, since the toothless part detection is prohibited for a period until the crankshaft 15 is rotated by a predetermined crank angle (360° C.A) after the start request is made (after the automatic-restart condition is established) (a period until the crank rotation speed is increased up to a speed at which the toothless part detection is possible), the erroneous detection of the exceeding of the top dead center as the toothless part of the timing rotor can be suppressed. In this manner, in the stop-and-start control, even in a case where the engine 1 is restarted by only combustion without using the starter 10, the erroneous detection of the crank position at the restart time of the engine 1 can be suppressed. Therefore, the startability of the engine 1 can be improved.

Toothless Part Detection Control 2

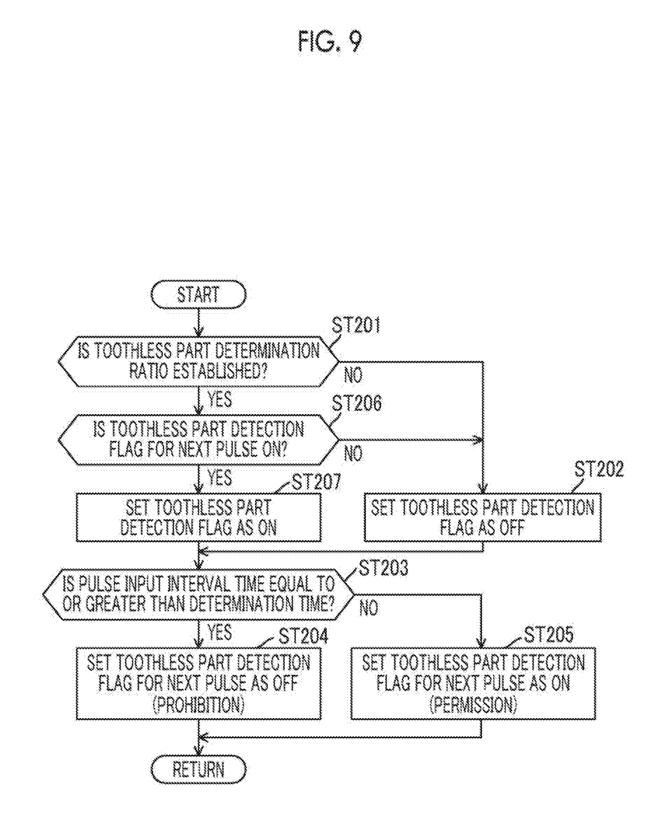

Another example of the toothless part detection control executed by the ECU 100 is described with reference to the flowchart in FIG. 9. The control routine in FIG. 9 is repeatedly executed by the ECU 100 whenever the pulse signal from the crank angle sensor 106 is input to the ECU 100 (pulse input). The ECU 100 measures a pulse input interval time as an interval time between the current pulse input and the previous pulse input whenever the ECU 100 executes the control routine in FIG. 9. The pulse input interval time between the current pulse input and the previous pulse input is referred to as the “current pulse input interval time”.

When the control routine in FIG. 9 is started, in step ST201, determination is made on whether a toothless part determination ratio is established. Specifically, in a case where a ratio of the current pulse input interval time to the previous pulse input interval time (pulse input interval ratio) is a value equal to or greater than a predetermined determination value (in this example, 2.4), determination is made that the toothless part determination ratio is established, and in a case where the pulse input interval ratio is a value less than the determination value, determination is made that the toothless part determination ratio is not established. In a case where the determination result of step ST201 is negative (NO) (in a case where the toothless part determination ratio is not established), the process proceeds to step ST202.

In step ST202, a toothless part detection flag is set as OFF. Then, the process proceeds to step ST203.

In step ST203, determination is made on whether the pulse input interval time (the interval time between the current pulse input and the previous pulse input) is equal to or greater than a predetermined determination time. The determination time used in the determination of step ST203 is a threshold for discriminating a case in which the exceeding of the top dead center is erroneously detected as the toothless part of the timing rotor from a case in which erroneous detection is not performed, and in a case where the crank rotation speed is slow and the pulse input interval time is equal to or greater than the determination time, determination is made that the top dead center is exceeded. A method of setting the determination time will be described below.

In a case where the determination result of step ST203 is positive (YES) (in a case of (pulse input interval time determination time)), the process proceeds to step ST204. In step ST204, the toothless part detection flag for the next pulse is set as OFF. Then, the process proceeds for return.

In a case where the pulse input interval time is equal to or greater than the determination time (in a case where the determination result of step ST203 is positive (YES)), the processes of step ST201 to step ST204 are repeatedly executed until the determination result of step ST201 is positive (YES). In such a state, in a case where the determination result of step ST201 is positive (YES), that is, in a case where the toothless part determination ratio is established in a state where the pulse input interval time is equal to or greater than the determination time, the process proceeds to step ST206.

In step ST206, determination is made on whether the toothless part detection flag for the next pulse is ON. At this time point, since the toothless part detection flag for the next pulse is set as OFF in previous step ST204, the determination result of step ST206 is negative (NO), the process returns to step ST202, and thus the toothless part detection flag is set as OFF. In this manner, even when the toothless part determination ratio is established, in a case where the immediately previous pulse input interval time (the previous pulse input interval time) is equal to or greater than the determination time and the crank rotation speed is slow, the toothless part detection is prohibited. Then, the process proceeds to step ST203.

In a case where the determination result of step ST203 is positive (YES), that is, in a case where the pulse input interval time is equal to or greater than the determination time, since the toothless part detection flag for the next pulse is set as OFF in step ST204, the prohibition of the toothless part detection continues. During the prohibition of the toothless part detection, determination is made on whether the current crank position is correct based on the cam signal of the cam angle sensor 107.

Meanwhile, in a case where the determination result of step ST203 is negative (NO), that is, in a case where the pulse input interval time is less than the determination time, the toothless part detection flag for the next pulse is set as ON in step ST205, and then the process returns to step ST201. In a case where the determination result of step ST201 is negative (NO), the processes of step ST201 to step ST203 and step ST205 are repeatedly executed. In such a state, in a case where the determination result of step ST201 is positive (YES), that is, in a case where the toothless part determination ratio is established in a state where the pulse input interval time is less than the determination time, the process proceeds to step ST206.

In step ST206, determination is made on whether the toothless part detection flag for the next pulse is ON. At this time point, since the toothless part detection flag for the next pulse is set as ON in previous step ST205, the process proceeds to step ST207. In step ST207, the toothless part detection flag is set as ON. In this manner, when the toothless part determination ratio is established, in a case where the immediately previous pulse input interval time (the previous pulse input interval time) is less than the determination time and the crank rotation speed is slow, the toothless part detection is permitted. At the time point when the toothless part detection flag is set as ON, determination is made that the toothless part (the reference position of the crank position) is detected. The crank position is calculated based on the above-described determination of the toothless part. Whether there is a deviation between the calculated crank position and the crank position that the ECU currently recognizes is checked, and in a case where there is a deviation in the crank position, the crank position is corrected based on the check result.

Determination Time Set for Pulse Input Interval Time

A method of setting the determination time used in the determination of step ST203 is described.

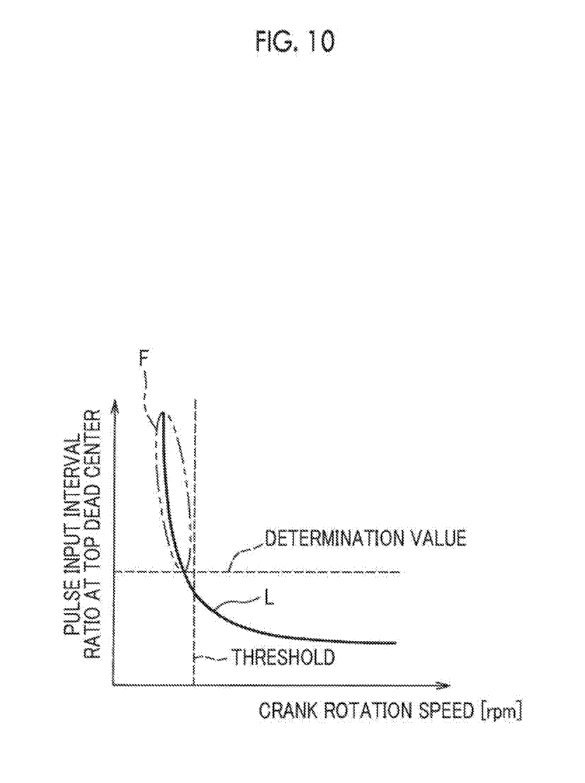

In a case where the top dead center is exceeded, as illustrated in FIG. 10, when the crank rotation speed is slow, there is a region where the pulse input interval ratio (ratio of the current pulse input interval time to the previous pulse input interval time) at the top dead center is equal to or greater than a predetermined value, that is, a region F where the toothless part determination ratio is established. In the region F, there is a possibility of erroneously detecting the exceeding of the top dead center as the toothless part of the timing rotor. In consideration of this, the region F is set as a region where the toothless part detection is not performed, and a threshold for discriminating the region F where the toothless part detection is not performed from a region where the toothless part detection is performed is set. Specifically, a value obtained by giving a margin to an upper limit value of the crank rotation speed in the region F where the toothless part detection is not performed is set as a threshold (broken line illustrated in FIG. 10). The threshold obtained as described above is converted into time, and the converted time is set as the determination time for discriminating the toothless part from the exceeding of the top dead center.

A curve L illustrated in FIG. 10 is a curve that is created by acquiring a relationship between the crank rotation speed and the pulse input interval ratio by calculation or the like with the crank rotation speed and the pulse input interval ratio at the top dead center as parameters and floating the acquired data.

Step ST201 to step ST207 in FIG. 9 are executed by the ECU 100, and thereby “the control device of the engine” of the disclosure is implemented.

Effect

As described above, with the toothless part detection control according this example, when a ratio of the current pulse input interval time to the previous pulse input interval time (pulse input interval ratio) is a value equal to or greater than the determination value (when the pulse input interval ratio is a value at which the predetermined toothless part determination ratio is established), in a case where the immediately previous pulse input interval time (the previous pulse input interval time) is equal to or greater than a predetermined determination time (in a case where the crank rotation speed is slow), determination is made that the top dead center is exceeded and thus the toothless part detection is prohibited. By such control, the erroneous detection of the exceeding of the top dead center as the toothless part of the timing rotor can be suppressed.

In this manner, in the stop-and-start control, even in a case where the engine 1 is restarted by only combustion without using the starter 10, the erroneous detection of the crank position can be suppressed. Therefore, the startability of the engine 1 can be improved.

### Other Embodiments

The embodiments disclosed here are examples in all aspects, and are not the basis of limited interpretation. Accordingly, the technical scope of the disclosure is not interpreted by only the above-described embodiments, and is defined based on the description of claims. The technical scope of the disclosure includes equivalent meaning as the claims and all the changes within the scope.

For example, in the above-described embodiments, in the stop-and-start control, an example in which the engine 1 is restarted by only combustion without using the starter 10 when the automatic-restart condition is established has been described, but the disclosure is not limited thereto. For example, even in a case where the starter 10 is used for restarting the engine 1, the crank rotation speed may be slow depending on conditions, and in such a case, the control device of the disclosure can be applied.

In the above-described embodiments, an example in which the disclosure is applied to an engine having four cylinders has been described, but the disclosure is not limited thereto. For example, the disclosure can be applied to a multiple cylinder engine having any number of cylinders such as six cylinders or eight cylinders.

What is claimed is:

1. A control device for an engine that includes a crank angle sensor and a timing rotor provided on a crankshaft of the engine, the timing rotor being provided with a plurality of teeth and a toothless part where at least one of the teeth is not provided on an outer periphery of the timing rotor, the crank angle sensor being configured to output a pulse signal according to passing of the teeth of the timing rotor,
the control device comprising
an electronic control unit configured to:
execute a stop-and-start control of automatically stopping the engine when a predetermined automatic stop condition is established and automatically restarting the engine when a predetermined automatic-restart condition is established during the automatic stop of the engine; and
when the automatic-restart condition is established during fuel cut-off according to the automatic stop of the engine, prohibit detection of the toothless part of the timing rotor based on the pulse signal output from the crank angle sensor, for a period until the crankshaft is rotated by a predetermined crank angle or more after the automatic-restart condition is established.

2. The control device according to claim 1, wherein the predetermined crank angle is set based on a period during which a rotation speed of the crankshaft is increased to a rotation speed at which the detection of the toothless part is possible after the automatic-restart condition is established.

3. A control device for an engine that includes a crank angle sensor and a timing rotor provided on a crankshaft of the engine, the timing rotor being provided with a plurality of teeth and a toothless part where at least one of the teeth is not provided on an outer periphery of the timing rotor, the crank angle sensor being configured to output a pulse signal according to passing of the teeth of the timing rotor,
the control device comprising
an electronic control unit configured to:
calculate a pulse input interval time when the pulse signal is input from the crank angle sensor;
calculate a pulse input interval ratio, the pulse input interval ratio is a ratio of a current pulse input interval time to a previous pulse input interval time; and
prohibit detection of the toothless part of the timing rotor based on the pulse signal output from the crank angle sensor when the calculated pulse input interval ratio is a value at which a predetermined toothless part determination ratio is established, in a case where the previous pulse input interval time of when the pulse input interval ratio is calculated is equal to or greater than a predetermined determination time.

4. The control device according to claim 3, wherein the predetermined determination time is set based on a rotation speed of the crankshaft at which there is a possibility of erroneously detecting the toothless part.

5. A control method for an engine that includes a crank angle sensor and a timing rotor provided on a crankshaft of the engine, the timing rotor being provided with a plurality of teeth and a toothless part where at least one of the teeth is not provided on an outer periphery of the timing rotor, the crank angle sensor being configured to output a pulse signal according to passing of the teeth of the timing rotor, the engine being controlled by an electronic control unit,
the control method comprising:
executing, by the electronic control unit, a stop-and-start control of automatically stopping the engine when a predetermined automatic stop condition is established and automatically restarting the engine when a predetermined automatic-restart condition is established during the automatic stop of the engine; and
when the automatic-restart condition is established during fuel cut-off according to the automatic stop of the engine, prohibiting, by the electronic control unit, detection of the toothless part of the timing rotor based on the pulse signal output from the crank angle sensor, for a period until the crankshaft is rotated by a predetermined crank angle or more after the automatic-restart condition is established.

6. A control method for an engine that includes a crank angle sensor and a timing rotor provided on a crankshaft of the engine, the timing rotor being provided with a plurality of teeth and a toothless part where at least one of the teeth is not provided on an outer periphery of the timing rotor, the crank angle sensor being configured to output a pulse signal according to passing of the teeth of the timing rotor, the engine being controlled by an electronic control unit,
the control method comprising:
calculating, by the electronic control unit, a pulse input interval time when the pulse signal is input from the crank angle sensor;
calculating, by the electronic control unit, a pulse input interval ratio, the pulse input interval ratio is a ratio of a current pulse input interval time to a previous pulse input interval time; and
prohibiting, by the electronic control unit, detection of the toothless part of the timing rotor based on the pulse signal output from the crank angle sensor when the calculated pulse input interval ratio is a value at which a predetermined toothless part determination ratio is established, in a case where the previous pulse input interval time of when the pulse input interval ratio is calculated is equal to or greater than a predetermined determination time.
